(19) United States
(12) Patent Application Publication
(10) Pub. No.: US 2023/0249408 A1
(43) Pub. Date: Aug. 10, 2023

(54) ELECTRICAL INDUCTION EXTRUDER APPARATUS

(71) Applicant: Benjamin Booker, Westminster, CO (US)

(72) Inventor: Benjamin Booker, Westminster, CO (US)

(21) Appl. No.: 18/107,949

(22) Filed: Feb. 9, 2023

Related U.S. Application Data
(60) Provisional application No. 63/308,462, filed on Feb. 9, 2022.

(51) Int. Cl. B29C 64/295; B33Y 10/00; B29C 64/209; B29C 48/505; B29C 64/255; B33Y 30/00

(52) U.S. Cl. CPC B29C 64/295; B33Y 10/00; B29C 64/209; B29C 48/505; B29C 64/255; B33Y 30/00; B29K 2105/0067

(57) ABSTRACT

An extruder system that includes an extruder apparatus for melting regolith to create a molten regolith. The extruder apparatus includes a chamber for receiving the regolith and an auger disposed in the chamger for forcing the regolight through the chamber. The extruder apparatus also includes copper wiring coiled around the chamber to create an induction field in the chamber to melt the regolith when alternating current is passed through the copper wiring. A method of generating molten regolith via electrical induction includes feeding regolith to the extruder apparatus and heating the regolith in the extruder apparatus via electrical induction to create a molten regolith. The method also includes extruding the molten regolith from the extruder apparatus.

### CROSS-REFERENCE TO RELATED APPLICATIONS

The present application is a conversion of U.S. Provisional Application having U.S. Ser. No. 63/308,462, filed Feb. 9, 2022 which claims the benefit under 35 U.S.C. 119(e). The disclosure of which is hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to additive manufacturing using terrestrial or extraterrestrial dirt, soil, regolith, or other materials in situ. More particularly, the invention relates to an extruder apparatus, heated by electrical induction which heats terrestrial or extraterrestrial dirt, soil, regolith, or other materials in situ to create a molten or near molten material to facilitate additive manufacturing layers.

### 2. Description of the Related Art

There are no similar additive manufacturing nozzle system known using the mechanism of the present disclosure.

Accordingly, there is a need for an extruder apparatus to facilitate additive manufacturing layers.

### SUMMARY OF THE DISCLOSURE

The present disclosure is directed to an extruder system that includes an extruder apparatus for melting regolith to create a molten regolith. The extruder apparatus includes a chamber for receiving the regolith and an auger disposed in the chamger for forcing the regolight through the chamber. The extruder apparatus also includes copper wiring coiled around the chamber to create an induction field in the chamber to melt the regolith when alternating current is passed through the copper wiring. The present disclosure is also directed toward a method of generating molten regolith. The method includes feeding regolith to the extruder apparatus and heating the regolith in the extruder apparatus via electrical induction to create a molten regolith. The method also includes extruding the molten regolith from the extruder apparatus.

### BRIEF DESCRIPTION OF THE DRAWINGS

FIG. 1 is a schematic of an extruder system constructed in accordance with the present disclosure.

FIG. 2A is a perspective view of an extruder apparatus constructed in accordance with the present disclosure.

FIG. 2B is a cross-sectional view of the extruder apparatus constructed in accordance with the present disclosure.

FIG. 2C is a close-up, cross-sectional view of a portion of the extruder apparatus constructed in accordance with the present disclosure.

FIG. 3 is a cross-sectional, perspective view of another embodiment of an extruder apparatus constructed in accordance with the present disclosure.

FIG. 4A is a perspective view of yet another embodiment of an extruder apparatus constructed in accordance with the present disclosure.

FIG. 4B is a cross-sectional, perspective view of the extruder apparatus shown in FIG. 4A and constructed in accordance with the present disclosure.

FIG. 4C is a cutaway, perspective view of the extruder apparatus shown in FIG. 4A and constructed in accordance with the present disclosure.

### DETAILED DESCRIPTION OF THE DISCLOSURE

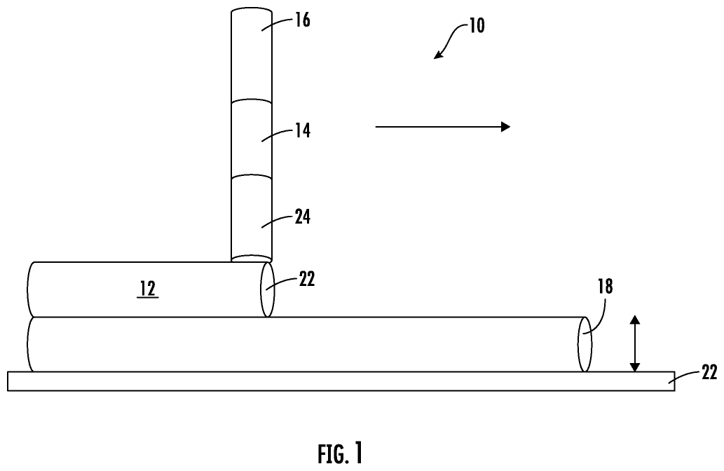

Referring now to the FIG. 1, shown therein is a schematice for an extruder system 10 for processing regolith into a molten, or near molten, substrate 12. When the term molten regolith is used herein, it includes near or partially molten regolith. The regolith can be fed to an extruder apparatus 14 via a regolith feeder 16 that directs the regolith to the extruder apparatus 14 where the regolith is heated via electrical induction into the molten substrate 12. The molten substrate 12 can be extruded from the extruder apparatus 14 in layer upon layer to manufacture structures. In FIG. 1, shown therein is a first layer 18 of molten substrate 12 deposited on a surface 20 and a second layer 22 of molten substrate 12 deposited on the first layer 18 of molten substrate 12. The molten substrate 12 can be forced from the extruder apparatus 14 via an extruder nozzle 24. As the molten regolith cools it creates a ceramic-like structure. In an exemplary embodiment, the extruder apparatus 14 can be used to process terrestrial or extraterrestrial dirt, soil, regolith on Earth, lunar, martian, regolith and the surface 20 the layered structure can be built on is the Earth, lunar, martian, surface.

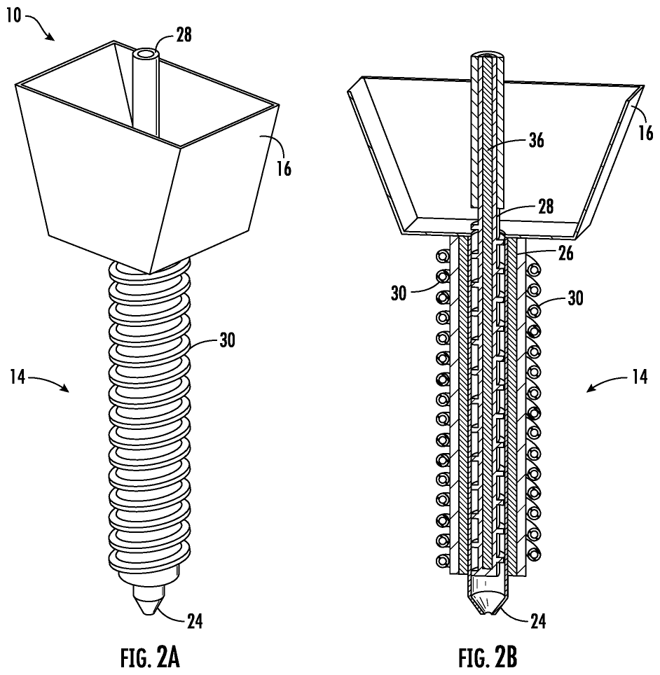

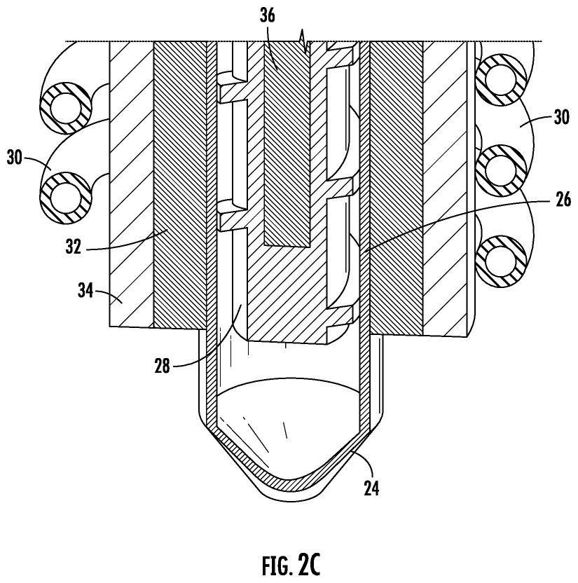

Referring now to FIGS. 2A-4C, shown therein is the extruder apparatus 14. The extruder apparatus 14 includes a chamber 26 where the regolith is fed into and melted to create molten, or near molten, regolith. An auger 28 is rotatably disposed in the chamber 26 to force the regolith into and through the chamber 26 towards the extruder nozzle 24 disposed on the end of the chamber 26 opposite the end of the chamber 26 where the regolith is fed. The auger 28 also forces the molten (or near molten) regolith (can be mounted vertically or horizontally) out of the extruder apparatus 14 via the extruder nozzle 24. Copper wiring 30 can be wrapped around the chamber 26 to create an induction field inside the chamber 26 when electricity is passed through the copper wiring 30. In one embodiment, the copper wiring 30 can be copper tubing wherein a coolant fluid can be flowed therethrough to cool the cooper wiring/tubing 30. To generate the temperatures necessary to melt the regolith material in the chamber 26, the chamber 26 and/or the auger 28 can be made of ferro magnetic materials. The creation of the induction field heats up the components of the extruder apparatus 14 made of ferro magnetic materials to temperatures above 1100° C. The induction field is created by passing an alternating current (AC) through the copper wiring or tubing 30. As the auger 28 cuases the regolith to pass through the chaber 26, the extremely high temperatures of the auger 28 and/or the chamber 26 melts the regolith to create the molted regolith.

An RF power source can be utilized to deliver the alternating current (AC) to the tank circuit during the induced heating procedure. The inductor is the copper wiring or tubing 30 to which current is applied. Inside this copper wiring or tubing 30, the chamber 26 to be heated is inserted.

In this method, specific and localized heating is detected because the eddy current created within the chamber 26 is contrary to the substance's electrical resistance. Hysteresis in the magnetic components (chamber 26 and/or auger 28) generates heat in addition to eddy currents. Inner resistance is caused by the electrical resistance given by paramagnetic material of the chamber 26 and/or the auger 28 to the varying magnetic field within the copper wiring 30 inductor. Heat is produced as a result of internal resistance. A temperature sensor can be used to monitor the temperature of the molten regolith in the chamber 26, or the chamber 26 itself. The temperature can be regulated by varying the intensity of the applied current to the copper winding 30.

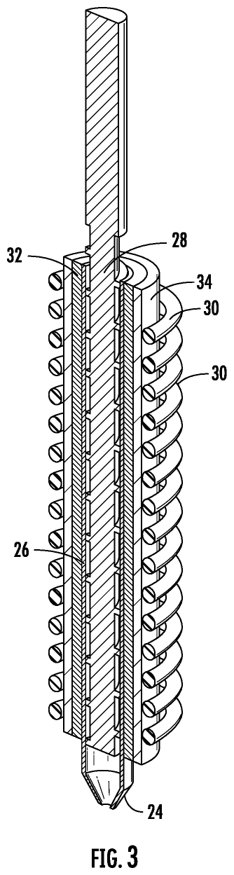

In another embodiment of the present disclosure shown in FIGS. 2A-3, the extruder apparatus 14 can include a susceptor sleeve 32 disposed around at least a portion of the chamber 26 and extend at least a part of the length of the chamber 26. The susceptor sleeve 32 can be constructed of any material capable of aborbing electromagnetic energy and converting it to heat to contribute to the melting of the regolith material. One example of material the susceptor sleeve 32 can be made of is carbon graphite, or other ferro magnetic material. In yet another embodiment, the extruder apparatus 14 can include an insulation sleeve 34 disposed around the susceptor sleeve 32 to insulate the heated components of the susceptor sleeve 32. The insulation sleeve 34 can be made up of any material capable of withstanding the operating conditions within the induction field, such as a ceramic material. One example of a ceramic material that can be used as the materal for the insulator sleeve 34 is aluminum oxide ceramic. It should be understood and appreciated that the copper wireing/tubing 30 can be disposed oustside of the susceptor sleeve 32 or the insulation sleeve 34 depending upon the specific setup of the extruder apparatus 14.

In a further embodiment shown in FIGS. 2A-2D, the auger 28 can have a susceptor core 36 disposed therein at least a portion of the length of the auger 28. The susceptor core 36 can be constructed of any material capable of aborbing electromagnetic energy and converting it to heat to contribute to the melting of the regolith material. One example of material the susceptor core 36 can be made of is carbon graphite. The extruder nozzle 24 is shown in the drawings as round, but it should be understood and appreciated that the extruder nozzle 24 can be any shape so as to be able to distribute the molten regolith as desired. The regolith feeder 16 can be any device known in the art for feeding material to the chamber 26 where the auger 28 can force it through the chamber 26 and melt it. One example of the regolith feeder 16 can be a hopper that holds the regolith and funnels it to the desired position.

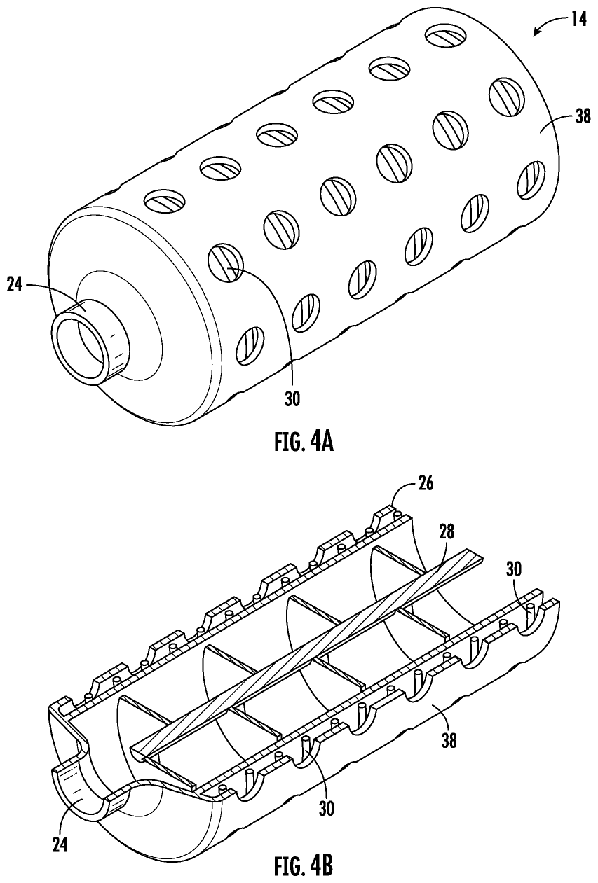

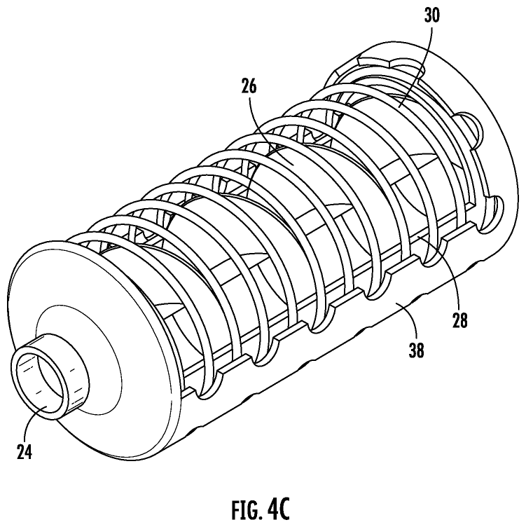

As shown in FIGS. 4A-4C, the extruder apparatus 14 can also include a vented scaffold 38 to encapsulate the various components of the extruder apparatus 14. The vented scaffold 38 could also be used to support the copper tubing/wiring 30 described herein. The vented scaffold 38 can extend any length of the extruder apparatus 14 and extend around any desired portions of the extruder apparatus 14.

The auger 28 and the chamber 26 can be constructed of any material capable of withstanding the extreme temperarures needed to melt regolith. Examples of materials include, but are not limited to, tungsten, molybdenum, or a combination thereof. These materials have melting points greater than 2600° C., which is significantly higher that the temperatures required to melt regolith materials—temperatures greater than 1300° C. (more specifically about 1380° C.).

The extruder apparatus 14 can be set up to be controlled by a computer-controlled 3D printing gantry system that can move the extruder apparatus 14 to desired positions or in a desired pattern to create a desired structure. The structures can be created by layering the molten regolith. Once a layer of molten regolith is extruded, it cools and hardens, binding it to the material it was placed on. Subsequent layers can be extruded onto previous layers and the heat from the layer being extruded causes the current extruded layer to bond to the previous layer. The bonding of the layers is what allows the extruder apparatus 14 to be such an effective tool for an additive manufacturing process.

The present disclosure can also be directed toward a method of extruding molten regolisth from the extruder apparatus 14, or construcing a structure from an additive manufacturing process. The method includes the step of providing regolith to the extruder apparatus 14, melting the regolith vie electrical induction and extruding the moltend regolith from the extruder apparatus 14. The method also includes generating multiple layers of extruded molten regolith to create a structure.

From the above description, it is clear that the present disclosure is well adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. An extruder system, the system comprising:
an extruder apparatus for melting regolith to create a molten regolith, the extruder apparatus comprises:
a chamber for receiving the regolith;
an auger disposed in the chamber for forcing the regolith through the chamber; and
copper wiring coiled around the chamber to create an induction field in the chamber to melt the regolith when alternating current is passed through the copper wiring.

2. The extruder system of claim 1 further comprising a an extruder nozzle on the chamber to provide the molten regolith extruded from the extruder apparatus with a desired shape.

3. The extruder system of claim 1 further comprising a regolith feeder to direct the regolith to the chamber.

4. The extruder system of claim 1 further comprising a suscepter sleeve disposed around the chamber and between the chamber and the copper wiring to assist in the generation of heat to melt the regolith.

5. The extruder system of claim 4 further comprising a suscepter core disposed in the auger to assist in the generation of heat to melt the regolith.

6. The extruder system of claim 5 further comprising an insulation sleeve disposed around the susceptor sleeve and between the susceptor sleeve and the copper wiring to help trap the heat generated from the induction field and melt the regolith.

7. The extruder system of claim 1 wherein the copper wiring is copper tubing such that a coolant fluid could be passed through the copper tubing.

8. The extruder system of claim 1 wherein the chamber and auger are at least partially constructed of ferro metallic material that can withstand temperatures in excess of 1500° C.

9. The extruder system of claim 5 wherein the susceptor sleeve and the susceptor core are at least partially constructed of carbon graphite.

10. The extruder system of claim 8 wherein the ferro metallic material can be molybdenum, tungsten, or a combination thereof.

11. The extruder system of claim 1 wherein the regolith is lunar regolith.

12. A method of generating molten regolith, the method comprising:
feeding regolith to an extruder apparatus;
heating the regolith in the extruder apparatus via electrical induction to create a molten regolith; and
extruding the molten regolith from the extruder apparatus.

13. The method of claim 12 further comprising creating a structure from the molten regolith by layering the molten regolith.

14. The method of claim 13 wherein the regolith is heated to a temperature greater than 1100° C.

15. The method of claim 12 wherein the extruder apparatus comprises:
a chamber for receiving the regolith;
an auger disposed in the chamber for forcing the regolith through the chamber; and
copper wiring coiled around the chamber to create an induction field in the chamber to melt the regolith when alternating current is passed through the copper wiring.

16. The method of claim 15 further comprising a suscepter sleeve disposed around the chamber and between the chamber and the copper wiring to assist in the generation of heat to melt the regolith.

17. The method of claim 16 further comprising a suscepter core disposed in the auger to assist in the generation of heat to melt the regolith.

18. The method of claim 17 further comprising an insulation sleeve disposed around the susceptor sleeve and between the susceptor sleeve and the copper wiring to help trap the heat generated from the induction field and melt the regolith.

19. The method of claim 15 wherein the chamber and auger are at least partially constructed of ferro metallic material that can withstand temperatures in excess of 1500° C.

20. The method of claim 12 wherein the regolith is lunar regolith.
